(19) United States
(12) Patent Application Publication
(10) Pub. No.: US 2022/0173509 A1
(43) Pub. Date: Jun. 2, 2022

(54) METHODS AND SYSTEMS FOR INERTIAL GUIDED ANTENNA POSITIONING

(71) Applicant: Comcast Cable Communications, LLC, Philadelphia, PA (US)

(72) Inventor: Farouk Zanaty, Philadelphia, PA (US)

(21) Appl. No.: 17/108,804

(22) Filed: Dec. 1, 2020

(51) Int. Cl. H01Q 3/08; H04B 17/327; H04B 17/345

(52) U.S. Cl. CPC H01Q 3/08; H04B 17/345; H04B 17/327

(57) ABSTRACT

A network device (e.g., a gateway device, a Wi-Fi modem, a router, an access point, a smart device, etc.) may be configured with one or more positional antennas and/or antenna units. The network device may dynamically position and/or reposition the one or more positional antennas and/or antenna units in three-dimensional (3D) space to achieve optimal aggregate performance (e.g., data throughput, signal power, signal integrity, etc.) when communicating with one or more user devices (e.g., smartphones, laptops, display devices, tablets, set-top boxes, content players, IoT devices, communication devices, etc.).

### BACKGROUND

Network devices (e.g., gateway devices, Wi-Fi modems, routers, access points, smart devices, etc.), in both private and public networks, wirelessly communicate with multiple devices. For example, a network device may be configured with one or more fixed position antennas that are used to wirelessly communicate with mobile devices, smart devices, Internet-of-things (IoT) devices, computing devices, and/or the like, and facilitate multiple connections to a network. Fixed antenna positions of a network device do not provide optimal aggregate performance (e.g., data throughput, signal power, signal integrity, etc.) when communicating with multiple devices at various distances and/or locations relative to the network device. For example, antennas of a network device configured with a fixed position to obtain aggregate performance data/information when communicating with multiple devices may not be positioned to enable the network device to obtain optimal aggregate performance data/information when a location of one or more of the devices relative to the network device changes to a new location. A network device configured with fixed antennas is unable to adapt to environments, such as environments where the locations of various devices in communication with the network device change often, to achieve optimal aggregate performance from each of the various devices.

### SUMMARY

It is to be understood that both the following general description and the following detailed description are exemplary and explanatory only and are not restrictive. Methods and systems for optimal antenna positioning are described.

A network device (e.g., a gateway device, a Wi-Fi modem, a router, an access point, a smart device, etc.) may be configured with one or more positional antennas and/or antenna units. An antenna unit may include a single antenna or a plurality of antennas. The network device may cause each antenna unit and/or each antenna of the antenna unit(s) to incrementally move to a different position in three-dimensional (3D) space. Each respective movement of the antennas and/or antenna unit(s) may be a movement to a different angular position, along each axis (e.g., x-axis, y-axis, z-axis, etc.) in 3D space. Each angular position may be separated by a configurable distance, such as a configurable step size in degrees. For example, each angular position may be separated by a degree (or more) of 360 degrees. The network device may measure and/or determine, after each respective movement of the antennas and/or antenna unit(s), an aggregate (and/or average) performance value based on performance data associated with each antenna unit and/or each antenna of the antenna unit(s), and each device of a plurality of devices in communication with the network device. The network device may analyze the aggregate (and/or average) performance value measured/determined at each respective angular position, for each antenna unit and/or each antenna of the antenna unit(s) to, determine an optimal aggregate (and/or average) performance value. The network device may cause each antenna unit and/or each antenna of the antenna unit(s) to move to the respective angular position for each antenna unit and/or each antenna of the antenna unit(s) associated with the optimal aggregate (and/or average) performance value. The network device may assign the respective angular position for each antenna unit and/or each antenna of the antenna unit(s) associated with the optimal aggregate (and/or average) performance value as a static and/or temporality fixed position. The network device may periodically reposition each antenna unit and/or each antenna of the antenna unit(s) to receive optimal aggregate performance and/or an aggregate performance value that achieves better aggregate (and/or average) performance value based on measurements within the cyclic period.

This summary is not intended to identify critical or essential features of the disclosure, but merely to summarize certain features and variations thereof. Other details and features will be described in the sections that follow.

### BRIEF DESCRIPTION OF THE DRAWINGS

The accompanying drawings, which are incorporated in and constitute a part of this specification, together with the description, serve to explain the principles of the methods and systems:

FIG. 1 shows an example system for optimal antenna positioning;

FIG. 2 shows an example system for optimal antenna positioning;

FIG. 3A shows an example antenna configuration for optimal antenna positioning;

FIG. 3B shows example antenna configurations for optimal antenna positioning;

FIG. 4 shows an example antenna position algorithm for optimal antenna

FIG. 5 shows an example flowchart of a method for optimal antenna positioning;

FIG. 6 shows an example flowchart of a method for optimal antenna positioning;

FIG. 7 shows an example flowchart of a method for optimal antenna positioning;

FIG. 8 shows an example flowchart of a method for optimal antenna positioning; and

FIG. 9 shows a block diagram of an example computing device for implementing optimal antenna positioning.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. When values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude other components, integers or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

This detailed description may refer to a given entity performing some action. It should be understood that this language may in some cases mean that a system (e.g., a computer) owned and/or controlled by the given entity is actually performing the action.

A network device (e.g., a gateway device, a Wi-Fi modem, a router, an access point, a smart device, etc.), for example, a network device configured within a private and/or public network, may wirelessly communicate with multiple user devices. For example, a network device may be configured with one or more positional antennas and/or antenna units that enable wireless communication with one or more user devices such as mobile devices, smart devices, Internet-of-things (IoT) devices, computing devices, and/or the like. The network device may dynamically position and/or reposition the one or more positional antennas and/or antenna units to achieve optimal aggregate performance (e.g., data throughput, signal power, signal integrity, etc.) when communicating with the one or more user devices. For example, the one or more user devices may be positioned at various distances and/or locations relative to the network device. The network device may dynamically position and/or reposition the one or more positional antennas and/or antenna units to achieve optimal aggregate performance based on the various distances and/or locations of the one or more user devices relative to the network device.

An antenna unit may include a single antenna or a plurality of antennas. The network device may cause each antenna unit and/or each antenna of the antenna unit(s) to incrementally move to a different position in three-dimensional (3D) space. Each respective movement of the antennas and/or antenna unit(s) may be a movement to a different angular position, along each axis (e.g., x-axis, y-axis, z-axis, etc.) in 3D space. Each angular position may be separated by a configurable step size in degrees. For example, each angular position may be separated by any measure within 360 degrees, such as a fraction of a degree, a degree, and/or more than a degree of 360 degrees. The network device may measure and/or determine, after each respective movement of the antennas and/or antenna unit(s), an aggregate performance value. The aggregate performance value may be based on performance data associated with each antenna unit and/or each antenna of the antenna unit(s), and each device of a plurality of devices in communication with the network device. The network device may analyze the aggregate performance value measured/determined at each respective angular position for each antenna unit and/or each antenna of the antenna unit(s) to determine an optimal aggregate performance value. The optimal aggregate performance value may be the highest determined aggregate performance value. All other measured and analyzed values may be discarded.

The network device may cause each antenna unit and/or each antenna of the antenna unit(s) to move to the respective angular position for each antenna unit and/or each antenna of the antenna unit(s) associated with the optimal (e.g., highest, etc.) aggregate performance value. The network device may assign the respective angular position for each antenna unit and/or each antenna of the antenna unit(s) associated with the optimal aggregate performance value as a static and/or temporality fixed position. The network device may periodically reposition each antenna unit and/or each antenna of the antenna unit(s) to receive optimal aggregate performance and/or an aggregate performance value that satisfies an aggregate performance threshold. The aggregate performance threshold may apply to any and/or all performance metrics (e.g. a highest measure of throughput, latency, jitter, a lowest quantity of packet loss, etc.). As described herein, the aggregate performance value may be based on performance data associated with each antenna unit and/or each antenna of the antenna unit(s), and each device of a plurality of devices in communication with the network device. An aggregate performance value may, in some scenarios, only include performance data associated with one or more devices of a plurality of devices in communication (and/or previously in communication) with the network device. For example, performance data associated with one or more of the devices in communication (and/or previously in communication) with the network device may be ignored/disregarded when determining an aggregate performance value.

Although the network device is described as determining an aggregate performance value based on performance data associated with each antenna unit and/or each antenna of the antenna unit(s), and each device of a plurality of devices in communication with the network device, the network device may also (and/or alternatively) determine a sum, an average, a fraction/portion, a factored value, and/or any numerical and/or statistical evaluation of the performance values based on performance data associated with each antenna unit and/or each antenna of the antenna unit(s), and each device of a plurality of devices in communication with the network device.

To cause each antenna unit and/or each antenna of the antenna unit(s) to move, for example to the respective angular position, the network device may include gimbals attached to antennas. For example, one or more actuators may drive the gimbals associated with each antenna unit and/or each antenna of the antenna unit(s). Each gimbal of the three gimbal may be associated with a respective axis in 3D space. A gyroscopic effect associated with each gimbal along each direction of the respective axis in 3D space may cause any gimbal to move to a stable position if an external force disturbs a position of the gimbal. For example, inertial guidance may be used to stabilize each antenna unit and/or each antenna of the antenna unit(s) to mitigate any unintentional movement of each antenna unit and/or each antenna of the antenna unit(s).

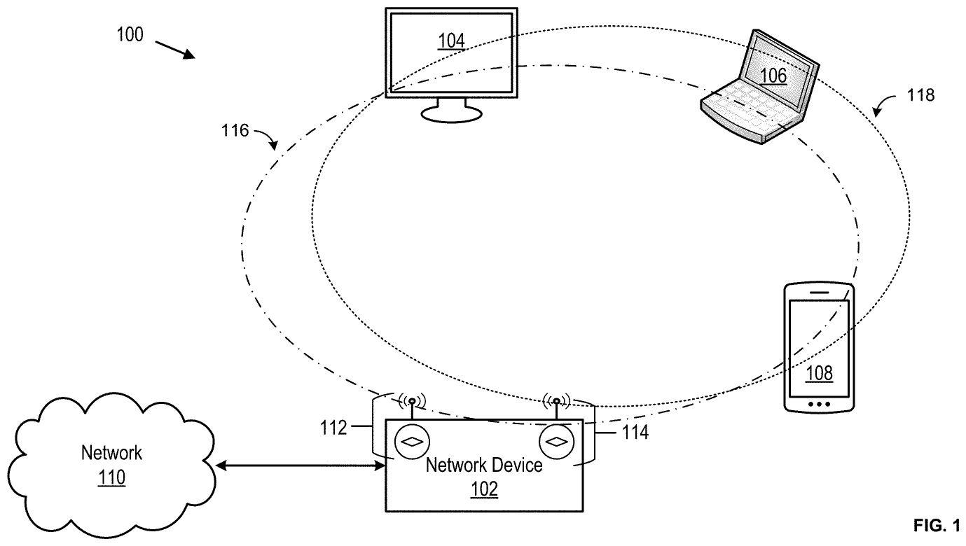

FIG. 1 shows an example system 100 for optimal antenna positioning. One skilled in the art will appreciate that provided herein is a functional description and that the respective functions may be performed by software, hardware, or a combination of software and hardware.

A network device 102 (e.g., a gateway device, a Wi-Fi modem, a router, an access point, a smart device, etc.) may communicate with multiple user devices (e.g., smartphones, laptops, display devices, tablets, set-top boxes, content players, IoT devices, communication devices, etc.) to establish, facilitate, and/or enable a connection to a network 110, such as a private network, a public network, a secured network, a local area network, a wide area network, Internet, a content access network, a content distribution network, and/or the like.

The network device 102 may be configured for dual-band wireless communication. The network device 102 may be, for example, configured with a first service set identifier (SSID) (e.g., associated with a user network or private network) to function as a local network for a particular user/user device or users/user devices. The network device 102 may be configured with a second service set identifier (SSID) (e.g., associated with a public/community network or a hidden network) to function as a secondary network or redundant network for connected user devices. The network device 102 may be configured with one or more identifiers (e.g., unique identifiers, random identifiers, persistent identifiers, temporary identifiers, etc.) for facilitating communications with/to the network 110. The one or more identifiers may include and/or be associated with an Internet Protocol (IP) Address IPV4/IPV6, a media access control address (MAC address), and/or any other identifiers.

The network device 102 may communicate and/or be in communication with a display device 104, a laptop 106, and a smart device 108 to establish, facilitate, and/or enable a connection to the network 110. The display device 104, the laptop 106, and the smart device 108 may each be positioned at various distances and/or locations relative to the network device 102. For example, in a private network environment, the network device 102 and the display device 104 may both be located on a first floor of a home/residence, the laptop 106 may be located on a second floor, and the smart device 108 may be located on a front porch/yard of the home/residence.

To wirelessly communicate and/or be in communication with the display device 104, the laptop 106, and the smart device 108, the network device 102 may be configured with positional antenna units 112 and 114. Although only the positional antenna units 112 and 114 are shown, the network device 102 may be configured with any number of positional antenna units. Each positional antenna unit (e.g., the positional antenna units 112 and 114, etc.) may be configured, for example, internal to the network device 102 and in communication with and/or configured with one or more transceivers of the network device 102. Each positional antenna unit (e.g., the positional antenna units 112 and 114, etc.) may include a single antenna or a plurality of antennas. Each positional antenna unit (e.g., the positional antenna units 112 and 114, etc.) may be, for example, attached to and/or configured with a gyroscope that enables the positional antenna unit to be positioned and/or repositioned in three-dimensional (3D) space.

Each positional antenna unit (e.g., the positional antenna units 112 and 114, etc.) may be associated with a communication range within which the positional antenna unit may communicate with user devices. For example, the positional antenna unit 112 may be associated with a communication range 116, and the positional antenna unit 114 may be associated with a communication range 118. A distance of a user device (e.g., the display device 104, the laptop 106, the smart device 108, etc.) relative to the positional antenna unit 112 may affect performance (e.g., data throughput, signal power, signal integrity, etc.) with respect to the user device within the communication range 116. A distance of a user device (e.g., the display device 104, the laptop 106, the smart device 108, etc.) relative to the positional antenna unit 114 may affect performance (e.g., data throughput, signal power, signal integrity, etc.) with respect to the user device within the communication range 118.

The network device 102 may position and/or reposition the positional antenna units (e.g., the positional antenna units 112 and 114, etc.) to achieve optimal aggregate performance (e.g., data throughput, signal power, signal integrity, etc.) when communicating with the display device 104, the laptop 106, and the smart device 108 to establish, facilitate, and/or enable a connection to the network 110. An aggregate performance value may be based on performance data associated with each antenna or plurality of antennas of a positional antenna unit (e.g., the positional antenna units 112 and 114, etc.) and the display device 104, the laptop 106, and/or the smart device 108, respectively. For example, during an initial start/power-up (e.g., when the network device is initially installed/configured a home/residence, etc.) the network device 102 may dynamically position each positional antenna unit (e.g., the positional antenna units 112 and 114, etc.) to achieve an optimal aggregate performance value relative to the various distances and/or locations of the display device 104, the laptop 106, and/or the smart device 108. The network device 102 may ignore/disregard performance data associated with one or more of the display device 104, the laptop 106, and/or the smart device 108 when determining an aggregate performance value and/or optimal aggregate performance value. For example, the network device 102 may dynamically position each positional antenna unit (e.g., the positional antenna units 112 and 114, etc.) to achieve an optimal aggregate performance value relative to the various distances and/or locations of the display device 104 and the laptop 106, and/or while ignoring/disregarding performance data associated with the smart device 108.

Although the network device 102 is described as determining an aggregate performance value and/or optimal aggregate performance value based on performance data associated with each positional antenna unit (e.g., the positional antenna units 112 and 114, etc.), and the display device 104, the laptop 106, and/or the smart device 108, the network device 102 may also (and/or alternatively) determine a sum, an average, a fraction/portion, a factored value, and/or any numerical and/or statistical evaluation of the performance values based on performance data associated with each positional antenna unit (e.g., the positional antenna units 112 and 114, etc.) and the display device 104, the laptop 106, and/or the smart device 108.

The network device 102 may determine a performance value (e.g., an aggregate performance value, an optimal performance value, a sum of performance values, an average of performance values, a fraction/portion of performance values, a factored value associated with performance values, etc.) based on performance data associated with any combination of positional antenna units (e.g., the positional antenna units 112 and 114, etc.), and devices (e.g., the display device 104, the laptop 106, the smart device 108, etc.). For example, a combination of positional antenna units and devices may include:
the positional antenna unit 112, the display device 104, the laptop 106, and the smart device 108
the positional antenna unit 112 and the display device 104
the positional antenna unit 112 and the laptop 106
the positional antenna unit 112 and the smart device 108
the positional antenna unit 112, the display device 104, and the laptop 106
the positional antenna unit 112, the display device 104, and the smart device 108
the positional antenna unit 112, the laptop 106, and the smart device 108
the positional antenna unit 114, the display device 104, the laptop 106, and the smart device 108
the positional antenna unit 114 and the display device 104
the positional antenna unit 114 and the laptop 106
the positional antenna unit 114 and the smart device 108
the positional antenna unit 114, the display device 104, and the laptop 106
the positional antenna unit 114, the display device 104, and the smart device 108
the positional antenna unit 114, the laptop 106, and the smart device 108
the positional antenna unit 112, the positional antenna unit 114, the display device 104, the laptop 106, and the smart device 108
the positional antenna unit 112, the positional antenna unit 114, and the display device 104
the positional antenna unit 112, the positional antenna unit 114, and the laptop 106
the positional antenna unit 112, the positional antenna unit 114, and the smart device 108
the positional antenna unit 112, the positional antenna unit 114, the display device 104, and the laptop 106
the positional antenna unit 112, the positional antenna unit 114, the display device 104, and the smart device 108
the positional antenna unit 112, the positional antenna unit 114, the laptop 106, and the smart device 108

Dynamically positioning each positional antenna unit may include causing each positional antenna unit to move to a different position in three-dimensional (3D) space. Movements of positional antenna units may include rotational movements about an axis in 3D space, such as incremental pitch rotations, incremental yaw rotations, and/or incremental roll rotations. The optimal aggregate performance value may be based on aggregate performance values determined after each movement of a positional antenna unit (e.g., the positional antenna units 112 and 114, etc.). All other measured and analyzed values may be discarded.

The optimal aggregate performance value may be set/assigned as a threshold aggregate performance value. Periodically, the network device 102 may reposition the positional antenna units (e.g., the positional antenna units 112 and 114, etc.) to achieve, at least, the threshold aggregate performance value and/or determine a new optimal aggregate performance value relative to the various distances and/or locations of a user device (e.g., the display device 104, the laptop 106, the smart device 108, etc.) in communication with the network device 102. The network device 102 may reposition the positional antenna units (e.g., the positional antenna units 112 and 114, etc.), for example, to determine a new optimal aggregate performance value, whenever an aggregate performance value does not satisfy the threshold aggregate performance value. Whenever the distance and/or location of the display device 104, the laptop 106, and/or the smart device 108 changes with respect to the network device 102, an aggregate performance value may not satisfy the threshold aggregate performance value. For example, if the smart device 108 is moved from the front porch/yard to the second floor of the home/residence, an aggregate performance value, such as a previously determined optimal aggregate performance value, may not satisfy the threshold aggregate performance value. The network device 102 may determine a new optimal aggregate performance value and/or set/assign a new threshold aggregate performance value.

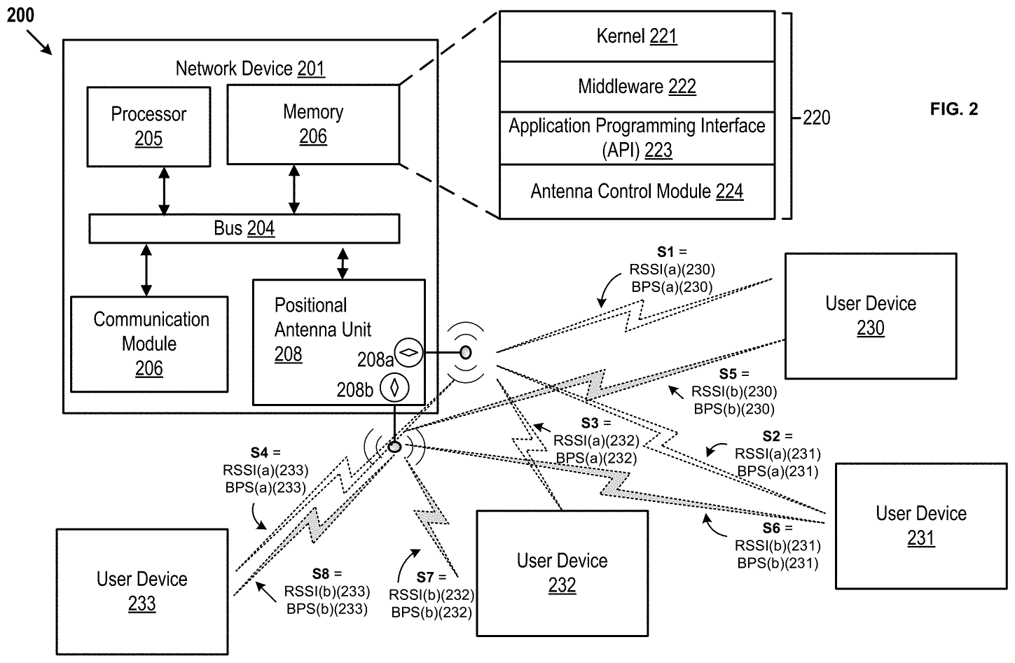

FIG. 2 shows an example system 200 for optimal antenna positioning. One skilled in the art will appreciate that provided herein is a functional description and that the respective functions may be performed by software, hardware, or a combination of software and hardware.

A network device 201 (e.g., a gateway device, a Wi-Fi modem, a router, an access point, a smart device, the network device 102, etc.) may communicate with user devices 230-233 (e.g., smartphones, laptops, display devices, tablets, set-top boxes, content players, IoT devices, communication devices, etc.) to establish, facilitate, and/or enable a connection to a network, such as a private network, a public network, a secured network, a local area network, a wide area network, Internet, a content access network, a content distribution network, and/or the like.

The network device 201 may include a bus 204, a processor 205, a communication module 206, memory 206, and a positional antenna unit 208. The network device 201 may omit at least one of the aforementioned constitutional elements or may additionally include other constitutional elements. For example, although only the positional antenna unit 208 is shown, the network device 201 may include any number/quantity of positional antenna units. The bus 204 may include a circuit for connecting the constitutional elements of the network device 201 to each other and for delivering communication (e.g., a control message and/or data) between the constitutional elements.

The processor 205 may include one or more of a Central Processing Unit (CPU), an Application Processor (AP), a Communication Processor (CP), and/or the like. The processor 335 may control, for example, at least one of other constitutional elements of the network device 201. The processor 205 may include processor executable instructions that, when executed, cause the network device 201 to perform any or all of the methods and/or steps for optimal antenna positioning described herein.

The communication module 206 may to establish, facilitate, and/or enable a communication between the network device, the user devices 230-233, and a network. The communication module 206 may include one or more of: a transceiver, a modem, a dual band wireless interface, a router, interfaces for supporting Wi-Fi Protected Setup (WPS), gigabit Ethernet Ports, and/or the like. The communication module 206 may support any suitable wired communication technique, such as Ethernet, coaxial cable, fiber optics, and/or the like. The communication module 206 may support data communications, voice communications, and/or the like. The communication module 206 may support any suitable wireless communication technique. For example, the communication module 206 may utilize any suitable long-range communication technique, such as Wi-Fi (IEEE 802.11), BLUETOOTH®, cellular, satellite, infrared, and/or the like. The communication module 206 may utilize any suitable short-range communication technique, such as BLUETOOTH®, near-field communication, infrared, and the like.

The memory 206 may include a volatile and/or non-volatile memory. The memory 206 may store, for example, a command and/or data related to at least one different constitutional element of network device 201. The memory 206 may store software, such as an application and/or a program 220. The program 220 may be configured for optimal antenna positioning. The program 220 may include, for example, a kernel 221, middleware 222, an Application Programming Interface (API) 223, an antenna control module 224, and/or the like.

At least one part of the kernel 221, middleware 222, or API 223 may be referred to as an Operating System (OS). The memory 206 may include a computer-readable recording medium having a program recorded therein to perform the method according to various embodiment by the processor 205.

The kernel 221 may control or manage, for example, system resources (e.g., the bus 204, the processor 205, the memory 206, etc.) used to execute an operation or function implemented in other programs (e.g., the API 223, the antenna control module 224, etc.). Further, the kernel 221 may provide an interface capable of controlling or managing the system resources by accessing individual constitutional elements of the network device 201 in the middleware 222, the API 223, and/or the antenna control module 224.

The middleware 222 may perform, for example, a mediation role so that the API 223, and/or the antenna control module 224 may communicate with the kernel 351 to exchange data.

Further, the middleware 222 may handle one or more task requests received from the API 223, and/or the antenna control module 224 according to a priority. For example, the middleware 222 may assign a priority of using the system resources (e.g., the bus 204, the processor 205, or the memory 26) of the network device 201 to the antenna control module 224. For instance, the middleware 222 may process the one or more task requests according to the priority assigned to the API 223, and/or the antenna control module 224, and thus may perform scheduling or load balancing on the one or more task requests.

The API 223 may include at least one interface or function (e.g., instruction), for example, for file control, data management, and/or antenna positioning/control, as an interface capable of controlling a function provided the antenna control module 224 in the kernel 221 or the middleware 222. For example, the interface may play a role in delivering an instruction or data input from a user or a different external device(s) to the different constitutional elements of the network device 201. Further, the interface may output an instruction or data received from the different constitutional element(s) of the network device 201 to the different external device.

The antenna control module 224 may receive data/information, such as power state information (e.g., power-on state, power-off state, etc.), activity information (e.g., actively communicating, not-actively communicating, etc.), and/or the like, from one or more transceivers configured with the communication module 206. Power state information may indicate whether the one or more transceivers are in a power-on state or a power-off state.

A power-on state may include, for example, a state where the one or more transceivers are receiving power from a power supply from a power supply/source configured/associated with the network device 201. A power-off state may include, for example, a state where the one or more transceivers are not receiving power from the power supply/source. Activity information may indicate whether the one or more transceivers are in an active state or idle state. An active state may include a state when the one or more transceivers are in a power-on state and operating, such as initiating a connection, communicating information, and/or terminating a connection with a user device (e.g., smartphones, laptops, display devices, tablets, set-top boxes, content players, IoT devices, communication devices, user devices 230-233, etc.). An idle state may represent a state where the one or more transceivers are in a power-on state and not operating, such as when no connections are determined, present, and/or detected.

The antenna control module 224 may be communicatively coupled to the positional antenna unit 208 (either directly or indirectly). The antenna control module 224 may receive data/information for, from, and/or associated with the one or more transceivers, and cause an antenna and/or plurality of antennas associated with one or more positional antenna units (e.g., the positional antenna unit 208, etc.) of the network device 201 to execute/perform simultaneous operations or mutually-exclusive operations, such as optimal antenna positioning. For example, the antenna control module 224 may receive activity information and generate a control signal and/or control data based on the activity information. The antenna control module 224 may send control signals and/or control data to each positional antenna unit (e.g., the positional antenna unit 208, etc.) of the network device 201, for example, to cause each positional antenna unit to incrementally move to a different position in three-dimensional (3D) space.

Each positional antenna unit (e.g., the positional antenna unit 208, etc.) of the network device 201 may include electrical, electronic, mechanical and/or electromagnetic elements configured to receive control signals and/or control data from the antenna control module 224 and facilitate movement (e.g., rotational movement, incremental pitch rotations, incremental yaw rotations, incremental roll rotations, etc.) of an antenna or a plurality of antennas of the positional antenna unit to a desired position, such as a position associated with optimal aggregate performance. For example, the positional antenna unit 208 may include electronics and/or one or more actuators, such as stepper motors, DC motors, AC motors, and/or any other type of electromagnetic motion producing device/component configured to rotate or translate an antenna or a plurality of antennas of the positional antenna unit 208.

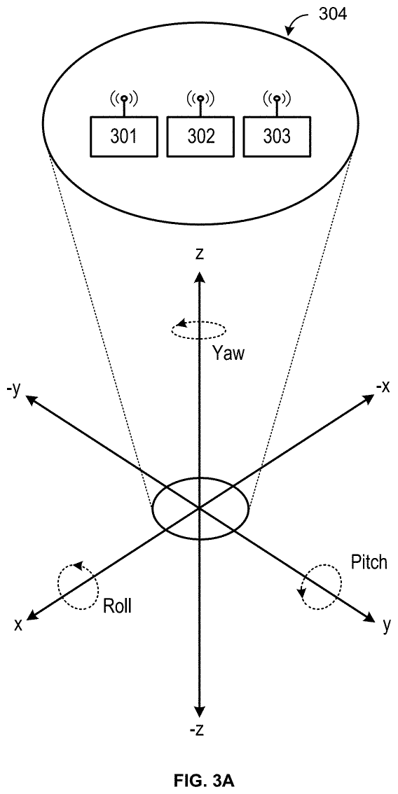

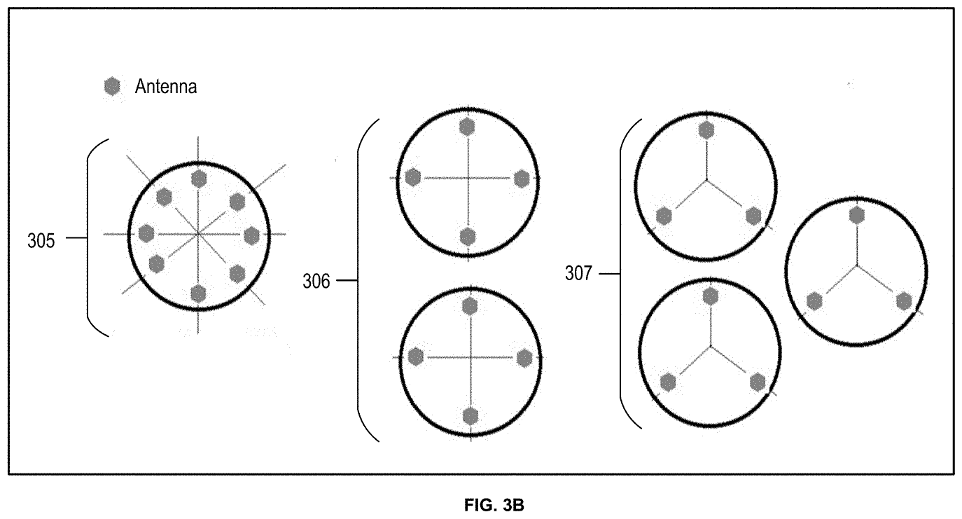

FIG. 3A shows example antennas of the positional antenna unit 208. The positional antenna unit 208 may include one or more antennas. For example, the positional antenna unit 208 may include antennas 301-303. Each antenna of the positional antenna unit 208 (e.g., the antennas 301-303, etc.) may be attached to a platform 304, such as a disk, a wafer, and/or the like. The platform 304 may be attached to and/or configured with a gyroscope (e.g., a 3-axis gimbal gyroscope, etc.) connected to, in communication with, and/or controlled by the antenna control module 224 (FIG. 2). The network device 201 may include any number/quantity of positional antenna units, each positional unit may include a platform, and each platform may include any number/quantity of antennas.

FIG. 3B shows examples of platforms of positional antenna units configured with various numbers/quantities of antennas. Example 305 is an example of a platform that may be attached to and/or configured with a gyroscope (e.g., a 3-axis gimbal gyroscope, etc.) connected to, in communication with, and/or controlled by the antenna control module 224 (FIG. 2). Example 305 includes eight antennas that may each communicate with one or more user devices. The eight antennas, based on performance data (e.g., data throughput, signal power, signal integrity, etc.) associated with each of the eight antennas and respective communications with the one or more user devices, may generate aggregate (and/or average) performance data. For example, the antenna control module 224 and/or processor 205 may receive the performance data associated with each of the eight antennas and the respective communications with the one or more user devices, and aggregate and/or average the received performance data. An aggregate (and/or average) of received performance data may be based on one or more antennas of the eight antennae and communications with any of the one or more user devices. Performance data associated with one or more antennas of the eight antennae and/or any user device of the one or more user devices may be ignored/disregarded when determining an aggregate (or average) of received performance data.

Example 306 is an example of two platforms that may be attached to and/or configured with separate gyroscopes (e.g., a 3-axis gimbal gyroscope, etc.) connected to, in communication with, and/or controlled by the antenna control module 224 (FIG. 2). Example 306 includes four antennas, attached to and/or configured with each of the two platforms, for a total of eight antennae that may each communicate with one or more user devices. The eight antennas based on performance data (e.g., data throughput, signal power, signal integrity, etc.) associated with each of the eight antennas and respective communications with the one or more user devices, may generate aggregate (and/or average) performance data. For example, the antenna control module 224 and/or processor 205 may receive the performance data associated with each of the eight antennas and the respective communications with the one or more user devices, and aggregate and/or average the received performance data. An aggregate (or average) of received performance data may be based on one or more antennas of the eight antennae and communications with any of the one or more user devices. Performance data associated with one or more antennas of the eight antennae and/or any user device of the one or more user devices may be ignored/disregarded when determining an aggregate (or average) of received performance data.

Example 307 is an example of three platforms that may be attached to and/or configured with separate gyroscopes (e.g., a 3-axis gimbal gyroscope, etc.) connected to, in communication with, and/or controlled by the antenna control module 224 (FIG. 2). Example 307 includes three antennas, attached to and/or configured with each of the three platforms, for a total of nine antennae that may each communicate with one or more user devices. The nine antennas based on performance data (e.g., data throughput, signal power, signal integrity, etc.) associated with each of the nine antennas and respective communications with the one or more user devices, may generate aggregate (and/or average) performance data. For example, the antenna control module 224 and/or processor 205 may receive the performance data associated with each of the nine antennas and the respective communications with the one or more user devices, and aggregate and/or average the received performance data. An aggregate (and/or average) of received performance data may be based on one or more antennas of the nine antennae and communications with any of the one or more user devices. Performance data associated with one or more antennas of the nine antennae and/or any user device of the one or more user devices may be ignored/disregarded when determining an aggregate (or average) of received performance data.

Returning to FIG. 2, the user devices 230-233 (e.g., smartphones, laptops, display devices, tablets, set-top boxes, content players, IoT devices, communication devices, etc.) may each be positioned at various distances and/or locations relative to the network device 201. For example, in a private network environment, the network device 201 and the user device 232 may both be located on a first floor of a home/residence, the user devices 230 and 231 may at different locations on a second floor, and the user device 233 may be located on a front porch/yard of the home/residence.

The network device 201 may cause, for example via movement (e.g., incremental movement, etc.) of an antenna(s) of the positional antenna unit 208 to incrementally move (e.g., spin, rotate, etc.) to a different position in three-dimensional (3D) space. Each respective movement of each antenna of the positional antenna unit 208 (e.g., the antennas 301-303, etc.) may be a movement to a different angular position, along each axis (e.g., x-axis, y-axis, z-axis, etc.) in 3D space. Movements of the positional antenna unit 208 may include rotational movements about an axis in 3D space, such as incremental pitch rotations, incremental yaw rotations, and/or incremental roll rotations. Each angular position may be separated by a configurable distance, such as a configurable step size in degrees. For example, each angular position may be separated by a degree or multiple degrees of 360 degrees.

For example, when the network device 201 is initially activated, turned on, and/or powered up, the antenna control module 224 may cause, via the respective gyroscopes, each positional antenna unit (e.g., the positional antenna unit 208, etc.) of the network device 201, to move 360 degrees in incremental pitch rotations, incremental yaw rotations, and/or incremental roll rotations. At each increment and/or angular position, the network device 201 may determine an aggregate (and/or average) performance value. The aggregate (and/or average) performance value may include and/or be based on performance data associated with antenna(s) of each positional antenna unit (e.g., the positional antenna unit 208, etc.) and each user device (e.g., the user devices 230-233, etc.) detected/determined and/or in communication with the network device 201. The network device 201 may analyze the aggregate (and/or average) performance value measured/determined at each respective angular position for each antenna(s) of each positional antenna unit (e.g., the positional antenna unit 208, etc.) and each user device (e.g., the user devices 230-233, etc.) detected/determined and/or in communication with the network device 201, and determine an optimal aggregate (and/or average) performance value. The optimal aggregate (and/or average) performance value may be the highest determined aggregate (and/or average) performance value.

For example, during an initial start/power-up (e.g., when the network device 201 is initially installed/configured a home/residence, etc.) the network device 201 may cause the positional antenna unit 208 to incrementally move (e.g., spin, rotate, etc.) to each position (e.g., angular position, etc.), for example, separated by a configurable distance (e.g., a configurable step size in degrees, etc.) such as a degree, along an axis and/or each axis (e.g., x-axis, y-axis, z-axis, etc.) in 3D space. Element 208a shows the antenna(s) of the positional antenna unit 208 at a first position in 3D space. At the first position, the network device 201 may determine aggregate performance data associated with the antenna(s) of the positional antenna unit 208 and the user devices 230-233, respectively.

Performance data may include and/or be associated with, for example, a received signal strength indication (RSSI) value and/or a throughput (measured in bits-per-second (bps)) value. At the first position, performance data associated with communication between the antenna(s) of the positional antenna unit 208 and the user device 230 may be indicated by S1. S1 may be used to denote an RSSI value determined between the positional antenna unit 208 and the user device 230 denoted as (RSSI)(a)(230), where “a” indicates the first position of the positional antenna unit 208 and “230” denotes the user device 230. S1 may be used to denote a data/information throughput value determined between the positional antenna unit 208 and the user device 230 denoted as (BPS)(a)(230), where “a” indicates the first position of the positional antenna unit 208 and “230” denotes the user device 230. Similar denotation convention, for example, S2, S3, and S4 are used to indicate, an RSSI value and/or throughput value determined between the antenna(s) of the positional antenna unit 208 and the user devices 231-233, respectively, at the first position. An aggregate performance value determined at the first position may include values for S1-S4.

Element 208b shows the antenna(s) of the positional antenna unit 208 at a second position in 3D space. At the second position, performance data associated with communication between the antenna(s) of the positional antenna unit 208 and the user device 230 may be indicated by S5. S5 may be used to denote an RSSI value determined between the positional antenna unit 208 and the user device 230 denoted as (RSSI)(a)(230), where “a” indicates the first position of the positional antenna unit 208 and “230” denotes the user device 230. S5 may be used to denote a data/information throughput value determined between the positional antenna unit 208 and the user device 230 denoted as (BPS)(b)(230), where “b” indicates the second position of the positional antenna unit 208 and “230” denotes the user device 230. Similar denotation convention, for example, S6, S7, and S8 may be used to indicate, an RSSI value and/or throughput value determined between the antenna(s) of the positional antenna unit 208 and the user devices 231-233, respectively, at the second position. An aggregate (and/or average) performance value determined at the second position may include values for S5-S8. Although only the first and second positions of the positional antenna unit 208 are shown, the network device 201 may cause the positional antenna unit 208 to move to any number/quantity of positions in 3D space, and determine an aggregate (and/or average) performance value at each position.

The network device 201 may determine an optimal average performance value. The optimal average performance value may be the highest aggregate performance value. For example, the network device may determine that the aggregate (and/or average) performance value determined at the first position (e.g., aggregated and/or averaged values for S1-S4, etc.) is −51 decibels (dB) and that the aggregate (and/or average) performance value determined at the second position (e.g., aggregated and/or averaged values for S5-S8, etc.) is −47 decibels (dB). The network device may determine that the aggregate (and/or average) performance value determined at the second position is higher (greater) than the aggregate (and/or average) performance value determined at the first position because −47 dB is a higher (greater) RSSI value than −51 dB.

The network device may determine that the aggregate (and/or average) performance value determined at the first position (e.g., aggregated and/or averaged values for S1-S4, etc.) is 350 kbps and that the aggregate (and/or average) performance value determined at the second position (e.g., aggregated and/or averaged values for S5-S8, etc.) is 420 kbps. The network device 201 may determine that the aggregate (and/or average) performance value determined at the second position is higher (greater) than the aggregate (and/or average) performance value determined at the first position because 420 kbps is a higher (greater) throughput value than 350 kbps.

The network device 201 may determine that the highest (greatest) aggregate (and/or average) performance value (e.g., aggregated and/or averaged values for S5-S8, etc.) is an optimal aggregate performance value. The network device 201, based on determining the optimal aggregate performance value, may cause the positional antenna unit 208 to move to the second position in 3D space. The network device 201 may assign/set the second position as a static and/or temporality fixed position for the positional antenna unit 208. The network device 201 may assign/set the optimal aggregate performance value as a threshold aggregate performance value.

Periodically, the network device 201 may reposition the positional antenna units (e.g., the positional antenna unit 208, etc.) to achieve, at least, the threshold aggregate performance value and/or determine a new optimal aggregate performance value relative to the various distances and/or locations of user devices in communication with the network device 201. The network device 201 may periodically reposition any positional antenna unit (e.g., the positional antenna unit 208, etc.) of the network device 201, either separately or collectively, to determine, receive, and/or achieve, at least, the threshold aggregate performance value and/or determine a new optimal aggregate performance value when communicating with user devices.

The network device 201 may reposition the positional antenna units (e.g., the positional antenna unit 208, etc.), for example, to determine a new optimal aggregate performance value, whenever an aggregate performance value does not satisfy the threshold aggregate performance value. Whenever the distance and/or location of the user devices 230-233 changes with respect to the network device 201, an aggregate performance value may not satisfy the threshold aggregate performance value. For example, if the user device 233 is moved from the front porch/yard to the second floor of the home/residence, an aggregate performance value, such as a previously determined optimal aggregate performance value, may not satisfy the threshold aggregate performance value. The network device 201 may determine a new optimal aggregate performance value and/or set/assign a new threshold aggregate performance value. If either of the user devices 230-233 move and/or are moved to different locations of the home/residence (or are removed from the system 200), the network device 201 may reposition any positional antenna unit (e.g., the positional antenna unit 208, etc.) of the network device 201, either separately or collectively, to determine, receive, and/or achieve, at least, the threshold aggregate performance value and/or determine a new optimal aggregate performance value when communicating with the user devices 230-233.

The network device 201 may periodically, for example, based on a preset and/or configurable time interval, reposition any positional antenna unit (e.g., the positional antenna unit 208, etc.) of the network device 201, either separately or collectively, to determine, receive, and/or achieve, at least, the threshold aggregate performance value and/or determine a new optimal aggregate performance value when communicating with the user devices 230-233.

An optimal aggregate performance value may be based on performance data associated with each positional antenna unit and/or each antenna of the positional antenna unit(s), and each of the user devices 230-233. An aggregate performance value may, in some scenarios, only include performance data associated with some user devices and/or a portion of the user devices 230-233. Performance data associated with a user device of the user devices 230-233 may be ignored/disregarded when determining an aggregate performance value. For example, performance data associated with the user devices 230-233 may be weighted and/or evaluated for a level of importance. The level of importance may be based on an amount of data communicated between the network device 201 and any user device of the user devices 230-233. The level of importance may be based on user preferences, provisioned configurations, a type of user device, a type of data/information communicated by a user device, and/or the like.

For example, the network device 201 may monitor data/information communicated between the network device 201 and any user device of the user devices 230-233 for a duration, during a period, and/or the like. If the network device 201 determines that an amount of data/information communicated between the network device 201 and any user device of the user devices 230-233 for the duration, during the period, and/or the like is below a threshold, then the network device 201 may only include performance data associated with user devices of the user devices 230-233 with an amount of data communicated that satisfies the threshold and ignore/disregard some/or all of the performance data from the user device of the user device 230-233 that had the amount of data/information below the threshold when determining an aggregate performance value.

The network device 201 may monitor data/information communicated between the network device 201 and any user device of the user devices 230-233 for example, a duration, during a period, and/or the like. If the network device 201 determines that a type of data/information communicated between the network device 201 and any user device of the user devices 230-233 for the duration, during the period, and/or the like is not of a certain data/information type, then the network device 201 may only include performance data associated with user devices of the user devices 230-233 of the certain data/information type and ignore/disregard some/or all of the performance data from the user device of the user device 230-233 that communicates data/information that is not of the certain data/information type when determining an aggregate performance value. The network device 201 may use any method/scheme to weight and/or account for performance data from user devices when determining an aggregate performance value.

The network device 201 may only include performance data associated with user devices of the user devices 230-233 and ignore/disregard some/or all of the performance data from other user devices of the user device 230-233 based on received configurations and/or settings. For example, the network device 201 may receive an indication of a priority list and/or weighting scheme associated with the user devices 230-233. The network device 201 may use the priority list and/or the weighting scheme associated with the user devices 230-233 to weight and/or account for performance data from user devices of the user devices 230-233 when determining an aggregate performance value.

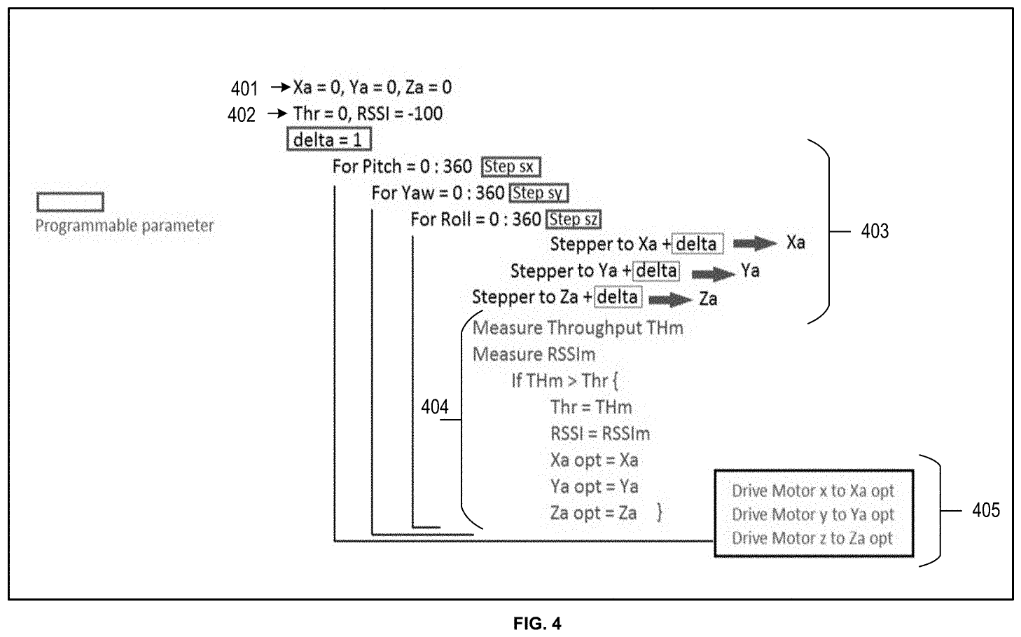

FIG. 4 shows an example control algorithm 400 for optimal antenna positioning. A network device (e.g., a gateway device, a Wi-Fi modem, a router, an access point, a smart device, the network device 102, the network device 201, etc.) may be configured with one or more positional antenna units. An antenna unit may include a single antenna or a plurality of antennas. Optimal antenna positioning may include positioning one or more positional antenna units to achieve the highest aggregate performance value (e.g., a highest aggregate RSSI value, a highest aggregate throughput value, etc.) based on performance data associated with the antenna(s) of the one or more positional antenna units and each user device of a plurality of user devices (e.g., smartphones, laptops, display devices, tablets, set-top boxes, content players, IoT devices, communication devices, etc.).

During, for example, an initial start/power-up (e.g., when the network device is initially installed/configured a home/residence, etc.) the network device may dynamically position antennas to achieve an optimal aggregate performance value. To determine the optimal aggregate performance value, the network device may execute/perform the control algorithm 400. The antenna(s) of the one or more positional antenna units may be attached to and/or configured with a platform, such as a disk, a wafer, apparatus, and/or the like. Each platform may be attached to a respective 3-axis gimballed gyroscope. The network device may cause, via the respective gyroscopes, each platform associated with each of the one or more positional antenna units to incrementally move to a different position in three-dimensional (3D) space. Each respective movement of the antennas and/or antenna unit(s) may be a movement to a different angular position, along each axis (e.g., x-axis, y-axis, z-axis, etc.) in 3D space. For example, the network device may cause each gyroscope to incrementally rotate/spin in each direction (e.g., pitch, roll, yaw, etc.) in 3D space.

At 401, the network device may determine initial values for the x-axis, y-axis, and z-axis, denoted Xa, Ya, Za, respectively. For example, initial values for Xa, Ya, Za may each be zero (0) to denote the initial/starting position of a platform attached to a gyroscope. As indicated at 402, the measured/determined throughput and RSSI may be zero (0) and −100 dB, respectively.

A configurable parameter, “delta” may indicate an amount of change and/or distance of movement between each incremental movement of the respective platform of the one or more positional antenna units about an axis. The delta value may be set to any value. As shown, the delta value may be set to one (1) to indicate that the amount of change and/or distance of movement between each incremental movement is one degree, from zero (0) to 360 degrees, about an axis. For example, as indicated by 403, the network device may cause the respective platform of the one or more positional antenna units to move in pitch, yaw, and roll directions in increments of one (1) degree.

Denoted by “stepper to Xa+delta→Xa; stepper to Ya+delta→Ya; and stepper to Za+delta→Za,” the network device may cause a respective stepper motor (or any other actuator) to drive each platform of the one or more positional antenna units about the x-axis, y-axis, and z-axis, wherein the next increment for each movement is equal to the last position on a respective axis and the configured value for delta.

As indicated at 404, after each incremental movement to an angular position, the network device may measure/determine an aggregate (and/or average) throughput value and an aggregate signal power (RSSI) value. The aggregate (and/or average) throughput value and/or the aggregate signal power (RSSI) value may be based on a throughput data value and/or RSSI value associated with each antenna of the one or more positional antenna units, and each user device of the plurality of user devices. An aggregate (and/or average) performance value may, in some scenarios, only include a throughput data value and/or RSSI value associated with one or more devices of the plurality of devices. For example, a throughput data value and/or RSSI value associated with one or more of the devices of the plurality of devices may be ignored/disregarded when determining an aggregate (and/or average) throughput value and an aggregate (and/or average) signal power (RSSI) value.

Although the network device is described as determining an aggregate (and/or average) throughput value and an aggregate signal power (RSSI) value based on a throughput data value and/or RSSI value associated with each antenna of the one or more positional antenna units, and each user device of the plurality of user devices, the network device may also (and/or alternatively) determine a sum, an average, a fraction/portion, a factored value, and/or any numerical and/or statistical evaluation of throughput values and/or RSI values based on a throughput data value and/or RSSI value associated with each antenna of the one or more positional antenna units, and each user device of the plurality of user devices.

If the measured/determined aggregate (and/or average) throughput value is greater than the threshold aggregate throughput value, then the network device may set the measured/determined aggregate throughput value at the angular position as the new threshold aggregate throughput value. If the measured/determined aggregate RSSI value is greater than the threshold aggregate RSSI value, then the network device may set the measured/determined aggregate RSSI value at the angular position as the new threshold aggregate RSSI value. For example, a network device (e.g., a gateway device, a Wi-Fi modem, a router, an access point, a smart device, the network device 102, the network device 201, etc.) may be configured with three positional antenna units. The network device may cause each of the three positional antenna units to move to a first position. At the first position, the network device may determine that the aggregate throughput value for devices communicating with the network device is 500 bps. The aggregate throughput value of 500 bps may be lower than a threshold aggregate throughput value of 600 bps. Based on the aggregate throughput value of 500 bps being lower than a threshold aggregate throughput value of 600 bps, the network device may cause each of the three positional antenna units to move to a second position. The network device may determine that the aggregate throughput value for devices communicating with the network device at the second position is 800 bps. The network device may cause each of the three positional antenna units to move to a third position. The network device may determine that the aggregate throughput value for devices communicating with the network device at the third position is less than 800 bps or does not satisfy the threshold aggregate throughput value of 600 bps. Based on the aggregate throughput value at the third position being lower than the threshold aggregate throughput value determined at the second position and/or less than the threshold aggregate throughput value of 600 bps, the network device may cause each of the three positional antenna units to move to the second position. The network device may set the throughput value of 800 bps as a new threshold aggregate throughput value.

A network device (e.g., a gateway device, a Wi-Fi modem, a router, an access point, a smart device, the network device 102, the network device 201, etc.) may be configured with three positional antenna units. The network device may cause each of the three positional antenna units to move to a first position. At the first position, the network device may determine that the aggregate throughput value for devices communicating with the network device is 500 bps. A device communicating with the network device may move and/or change positions causing the aggregate throughput value to be less than 500 bps. The network device may cause each of the three positional antenna units to move to different positions until the network device determines that an aggregate throughput value satisfies or exceeds an aggregate throughput value of 500 bps.

The network device may continue to perform similar measurements and/or determinations for each incremental movement, according to the “delta” value, from zero (0) to 360 degrees about each axis in 3D space. An angular position associated with the highest measured/determined aggregate throughput value and/or the highest measured/determined aggregate RSSI value may be set at a static and/or temporary angular position for the one or more positional antenna units.

As indicated at 405, the network device may cause a respective stepper motor (or any other actuator) to drive each platform of the one or more positional antenna units about the x-axis, y-axis, and z-axis to the angular position associated with the highest measured/determined aggregate throughput value and/or the highest measured/determined aggregate RSSI value.

A respective stepper motor (or any other actuator) may drive at least three respective gimbals associated with each platform. Each gimbal of the respective three gimbals may be associated with a respective axis in 3D space. A gyroscopic effect associated with each gimbal of the at least three respective gimbals along each direction of the respective axis in 3D space may cause any gimbal of the at least three gimbals to move to a stable position if an external force disturbs a position of the gimbal. For example, inertial guidance may be used to stabilize the platform to mitigate any unintentional movement associated with each platform.

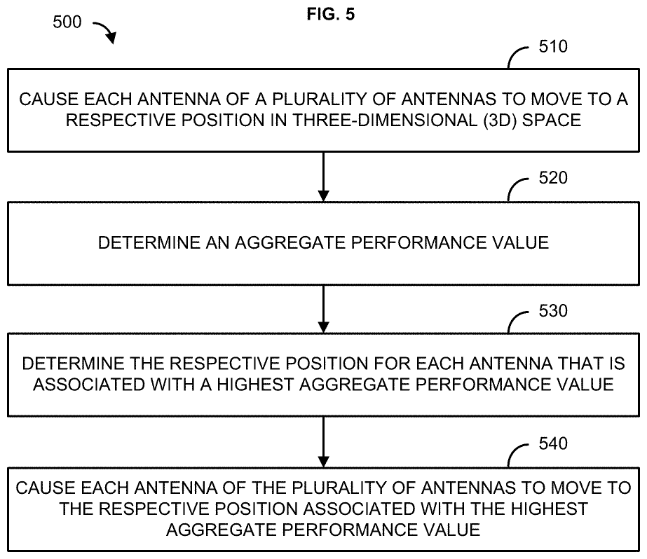

FIG. 5 is a flowchart of an example method 500 for optimal antenna positioning. A network device (e.g., a gateway device, a Wi-Fi modem, a router, an access point, a smart device, the network device 102, the network device 201, etc.), for example, a network device configured within a private and/or public network, may wirelessly communicate with multiple user devices. For example, the network device may be configured with a plurality of antennas that enable wireless communication with one or more user devices, such as mobile devices, smart devices, Internet-of-things (IoT) devices, computing devices, and/or the like. The network device may dynamically position and/or reposition the plurality of antennas to achieve optimal aggregate performance (e.g., data throughput, signal power, signal integrity, etc.) when communicating with the one or more user devices. For example, the one or more user devices may be positioned at various distances and/or locations relative to the network device. The network device may position and/or reposition the one or more positional antennas and/or antenna units to achieve optimal aggregate performance based on the various distances and/or locations of the one or more user devices relative to the network device.

The network device may determine a performance value (e.g., an aggregate performance value, an optimal performance value, a sum of performance values, an average of performance values, a fraction/portion of performance values, a factored value associated with performance values, etc.) based on performance data associated with any combination of antennas and user devices. For example, a network device configured with antennas A, B, and C, and in communication with user devices 1, 2, and 3, may determine a performance value based on performance data associated with different combinations of antenna and user devices such as: only antenna A; only antenna B; only antenna C; antennas A and B; antennas A and C; and/or antennas A, B, and C, combined with: only user device 1; only user device 2; only user device 3; user devices 1 and 2, user devices 1 and 3, and/or user devices 1, 2, and 3.

At 510, the network device may cause each antenna of the plurality of antennas to move to a respective position of a plurality of positions in three-dimensional (3D) space. For example, each antenna of the plurality of antennas may be attached to a respective 3-axis gimballed gyroscope. The network device may cause, via the respective gyroscopes, each antenna of the plurality of antennas to incrementally move to a different position in three-dimensional 3D, for example, the respective positions of the plurality of positions in 3D space. Each position of the plurality of positions may be separated, for example, by a degree in 3D space. Each position of the plurality of positions may be separated, for example, by any value in 3D space.

At 520, the network device may determine, at the respective positions of the plurality of positions, an aggregate performance value. The aggregate performance value may be based on performance data associated with each antenna of the plurality of antennas and each device of a plurality of devices in communication with the network device. The performance data associated with each antenna of the plurality of antennas and each device of the plurality of devices may include at least one of: a received signal strength indicator (RSSI) value associated with each device of the plurality of devices determined by the respective antenna, or data throughput associated with each device of the plurality of devices determined by (e.g., determined by the network device to be associated with) the respective antenna.

At 530, the network device may determine, for each antenna of the plurality of antennas, the respective position of the plurality of positions associated with a highest aggregate performance value. For example, to determine the respective position of the plurality of positions for each antenna of the plurality of antennas associated with the highest aggregate performance value, the network device may cause each antenna of the plurality of antennas to move to a first respective position (e.g., angular position, etc.) of the plurality of positions. To cause each antenna of the plurality of antennas to move to a first respective position, the network device may be configured with one or more actuators. The network device may actuate the one or more actuators to cause each antenna of the plurality of antennas to move to the first respective positions. The one or more actuators may include one or more stepper motors, one or more DC motors, one or more AC motors, and/or any other actuators.

The network device may determine a first aggregate performance value associated with the first respective positions. The first aggregate performance value may be based on first performance data associated with each antenna of the plurality of antennas and each device of the plurality of devices. The network device may assign the first aggregate performance value associated with the first respective positions as the highest aggregate performance value. The network device may cause each antenna of the plurality of antennas to move to a second respective position of the plurality of positions. The network device may determine that a second aggregate performance value associated with the second respective positions is higher than the first aggregate performance value. The second aggregate performance value may be based on second performance data associated with each antenna of the plurality of antennas and each device of the plurality of devices. The network device may assign, based on determining that the second aggregate performance value is higher than the first aggregate performance value, the second aggregate performance value as the highest aggregate performance value. The network device may perform similar actions to determine the highest aggregate performance value based on any number of aggregate performance values associated with any number of respective positions (e.g., angular positions, etc.) determined from zero (0) degrees to 360 degrees in 3D space, about each axis in 3D space. The highest aggregate performance value may be an optimal aggregate performance value.

To determine the respective position of the plurality of positions for each antenna of the plurality of antennas associated with the highest aggregate performance value, the network device may determine and compare the aggregate performance values determined at the respective positions of the plurality of positions to aggregate performance values determined at remaining respective positions of the plurality of positions. For example, rather than comparing an aggregate performance value determined at each angular position in 3D space to a next aggregate performance determined at a next angular position in 3D space, and determining the highest aggregate performance value at each iteration, the network device may make a final comparison of the aggregate performance values determined at each angular position in 3D space. The network device may determine based on the final comparison, that the respective positions of the plurality of positions are associated with the highest aggregate performance value. The highest aggregate performance value may be an optimal aggregate performance value.

At 540, the network device may assign the respective positions of the plurality of positions associated with the highest aggregate performance value as respective static positions for the plurality of antennas. The network device may cause each antenna of the plurality of antennas to move to the respective static positions. For example, the network device may actuate the one or more actuators to cause each antenna of the plurality of antennas to move to the respective static positions. Causing each antenna of the plurality of antennas to move to the respective static positions may achieve optimal antenna positioning.

The one or more actuators may drive at least three gimbals associated with the plurality of antennas. Each gimbal of the three gimbals may be associated with a respective axis in 3D space. A gyroscopic effect associated with each gimbal of the at least three gimbals along each direction of the respective axis in 3D space may cause any gimbal of the at least three gimbals to move to a stable position if an external force disturbs a position of the gimbal. For example, inertial guidance may be used to stabilize an antenna and/or plurality of antennas to mitigate any unintentional movement of the antenna and/or the plurality of antennas.

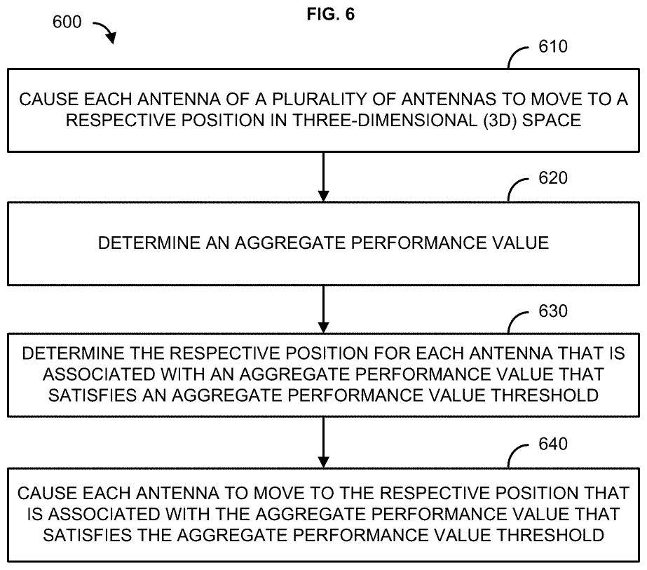

FIG. 6 is a flowchart of an example method 600 for optimal antenna positioning. A network device (e.g., a gateway device, a Wi-Fi modem, a router, an access point, a smart device, the network device 102, the network device 201, etc.), for example, a network device configured within a private and/or public network, may wirelessly communicate with multiple user devices. For example, the network device may be configured with a plurality of antennas that enable wireless communication with one or more user devices, such as mobile devices, smart devices, Internet-of-things (IoT) devices, computing devices, and/or the like. The network device may dynamically position and/or reposition the plurality of antennas to achieve optimal aggregate performance (e.g., data throughput, signal power, signal integrity, etc.) when communicating with the one or more user devices. For example, the one or more user devices may be positioned at various distances and/or locations relative to the network device. The network device may position and/or reposition the one or more positional antennas and/or antenna units to achieve optimal aggregate performance based on the various distances and/or locations of the one or more user devices relative to the network device.

The network device may determine a performance value (e.g., an aggregate performance value, an optimal performance value, a sum of performance values, an average of performance values, a fraction/portion of performance values, a factored value associated with performance values, etc.) based on performance data associated with any combination of antennas and user devices. For example, a network device configured with antennas A, B, and C, and in communication with user devices 1, 2, and 3, may determine a performance value based on performance data associated with different combinations of antenna and user devices such as: only antenna A; only antenna B; only antenna C; antennas A and B; antennas A and C; and/or antennas A, B, and C, combined with: only user device 1; only user device 2; only user device 3; user devices 1 and 2, user devices 1 and 3, and/or user devices 1, 2, and 3.

At 610, the network device may cause each antenna of the plurality of antennas to move to a respective position of a plurality of positions in three-dimensional (3D) space. For example, each antenna of the plurality of antennas may be attached to a respective 3-axis gimballed gyroscope. The network device may cause, via the respective gyroscopes, each antenna of the plurality of antennas to incrementally move to a different position in three-dimensional 3D, for example, the respective positions of the plurality of positions in 3D space. Each position of the plurality of positions may be separated, for example, by a degree in 3D space. Each position of the plurality of positions may be separated, for example, by any value in 3D space.

At 620, the network device may determine, at the respective positions of the plurality of positions, an aggregate performance value. The aggregate performance value may be based on performance data associated with each antenna of the plurality of antennas and each device of a plurality of devices in communication with the network device. The performance data associated with each antenna of the plurality of antennas and each device of the plurality of devices may include at least one of: a received signal strength indicator (RSSI) value associated with each device of the plurality of devices determined by the respective antenna, or data throughput associated with each device of the plurality of devices determined by the respective antenna.

At 630, the network device may determine, for each antenna of the plurality of antennas, the respective position of the plurality of positions associated with the aggregate performance value that satisfies an aggregate performance value threshold. The aggregate performance value threshold may be based on a historic aggregate performance value determined, for example, based on historic performance data associated with each antenna of the plurality of antennas and each device of a plurality of devices previously in communication with the network device.

At 640, the network device may assign the respective positions of the plurality of positions associated with the aggregate performance value that satisfies the aggregate performance value threshold, as respective static positions for the plurality of antennas. The network device may cause each antenna of the plurality of antennas to move to the respective static positions. To cause each antenna of the plurality of antennas to move to the respective static positions, the network device may be configured with one or more actuators. The network device may actuate the one or more actuators to cause each antenna of the plurality of antennas to move to the respective static positions. The one or more actuators may include one or more stepper motors, one or more DC motors, one or more AC motors, and/or any other actuators.

For example, the one or more actuators may drive at least three gimbals associated with the plurality of antennas. Each gimbal of the three gimbals may be associated with a respective axis in 3D space. A gyroscopic effect associated with each gimbal of the at least three gimbals along each direction of the respective axis in 3D space may cause any gimbal of the at least three gimbals to move to a stable position if an external force disturbs a position of the gimbal. For example, inertial guidance may be used to stabilize an antenna and/or plurality of antennas to mitigate any unintentional movement of the antenna and/or the plurality of antennas.

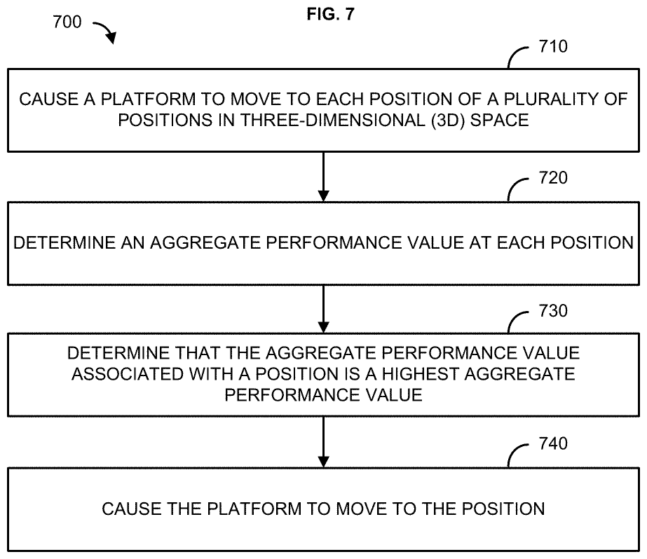

FIG. 7 is a flowchart of an example method 700 for optimal antenna positioning. A network device (e.g., a gateway device, a Wi-Fi modem, a router, an access point, a smart device, the network device 102, the network device 201, etc.), for example, a network device configured within a private and/or public network, may wirelessly communicate with multiple user devices. For example, the network device may be configured with a plurality of antennas that enable wireless communication with one or more user devices, such as mobile devices, smart devices, Internet-of-things (IoT) devices, computing devices, and/or the like. The network device may dynamically position and/or reposition the plurality of antennas to achieve optimal aggregate performance (e.g., data throughput, signal power, signal integrity, etc.) when communicating with the one or more user devices. For example, the one or more user devices may be positioned at various distances and/or locations relative to the network device. The network device may position and/or reposition the one or more positional antennas and/or antenna units to achieve optimal aggregate performance based on the various distances and/or locations of the one or more user devices relative to the network device.

The network device may determine a performance value (e.g., an aggregate performance value, an optimal performance value, a sum of performance values, an average of performance values, a fraction/portion of performance values, a factored value associated with performance values, etc.) based on performance data associated with any combination of antennas and user devices. For example, a network device configured with antennas A, B, and C, and in communication with user devices 1, 2, and 3, may determine a performance value based on performance data associated with different combinations of antenna and user devices such as: only antenna A; only antenna B; only antenna C; antennas A and B; antennas A and C; and/or antennas A, B, and C, combined with: only user device 1; only user device 2; only user device 3; user devices 1 and 2, user devices 1 and 3, and/or user devices 1, 2, and 3.

At 710, the network device may cause a platform (e.g., a disk, a surface, an apparatus, etc.) to move to each position of a plurality of positions in three-dimensional (3D) space. For example, a plurality of antenna of the network device may be attached to and/or configured with the platform. The platform may include, for example, a disk, a wafer, and/or the like. The platform may be attached to a 3-axis gimballed gyroscope. The network device may cause, via the gyroscope, the platform to incrementally move to each position in three-dimensional 3D. Each position of the plurality of positions may be separated, for example, by a degree in 3D space. Each position of the plurality of positions may be separated, for example, by any value in 3D space.

At 720, the network device may determine, at each position of the plurality of positions, an aggregate performance value. The aggregate performance value may be based on performance data associated with each antenna of the plurality of antennas and each device of a plurality of devices in communication with the network device. The performance data associated with each antenna of the plurality of antennas and each device of the plurality of devices comprises at least one of: a received signal strength indicator (RSSI) value associated with each device of the plurality of devices determined to be in communication with the network device, or data throughput associated with each device of the plurality of devices determined to be in communication with the network device.

At 730, the network device may determine that the aggregate performance value associated with a position of the plurality of positions is a highest aggregate performance value. For example, to determine that the aggregate performance value associated with the position of the plurality of positions is the highest aggregate performance value, the network device may cause the platform to move to a first position (e.g., angular position, etc.) of the plurality of positions. To cause the platform to move to the first position, the network device may be configured with one or more actuators. The network device may actuate the one or more actuators to cause the platform to move to the first position. The one or more actuators may include one or more stepper motors, one or more DC motors, one or more AC motors, and/or any other actuators. For example, the one or more actuators may drive at least three gimbals attached to the platform. Each gimbal of the three gimbals may be associated with a respective axis in 3D space. A gyroscopic effect associated with each gimbal of the at least three gimbals along each direction of the respective axis in 3D space may cause any gimbal of the at least three gimbals to move to a stable position if an external force disturbs a position of the gimbal. For example, inertial guidance may be used to stabilize the platform to mitigate any unintentional movement of the platform.

The network device may determine a first aggregate performance value associated with the first position. The first aggregate performance value may be based on first performance data associated with each antenna of the plurality of antennas and each device of the plurality of devices. The network device may assign the first aggregate performance value as the highest aggregate performance value. The network device may cause the platform to move to a second position of the plurality of positions. The network device may determine that a second aggregate performance value associated with the second position is higher than the first aggregate performance value. The second aggregate performance value may be based on second performance data associated with each antenna of the plurality of antennas and each device of the plurality of devices.

The network device may assign, based on determining that the second aggregate performance value is higher than the first aggregate performance value, the second aggregate performance value as the highest aggregate performance value. The network device may perform similar actions to determine the highest aggregate performance value based on any number of aggregate performance values associated with any number of positions (e.g., angular positions, etc.) determined from zero (0) degrees to 360 degrees in 3D space, about each axis in 3D space. The highest aggregate performance value may be an optimal aggregate performance value.

To determine that the aggregate performance value associated with the position of the plurality of positions is the highest aggregate performance value, the network device may determine and compare the aggregate performance value determined at the position to the aggregate performance values determined at the remaining positions of the plurality of positions. For example, rather than comparing an aggregate performance value determined at each angular position in 3D space to a next aggregate performance determined at a next angular position in 3D space, and determining the highest aggregate performance value at each iteration, the network device may make a final comparison of the aggregate performance values determined at each angular position in 3D space. The network device may determine based on the final comparison, that the position is associated with the highest aggregate performance value. The network device may assign, based on determining that the second aggregate performance value is higher than the first aggregate performance value, the second aggregate performance value as the highest aggregate performance value. The highest aggregate performance value may be an optimal aggregate performance value.

At 740, the network device may assign the position as a static position for the platform. The network device may cause the platform to move to the static position. For example, the network device may actuate the one or more actuators to cause the platform to move to the static position. Causing the platform to move to the static position may achieve optimal antenna positioning.

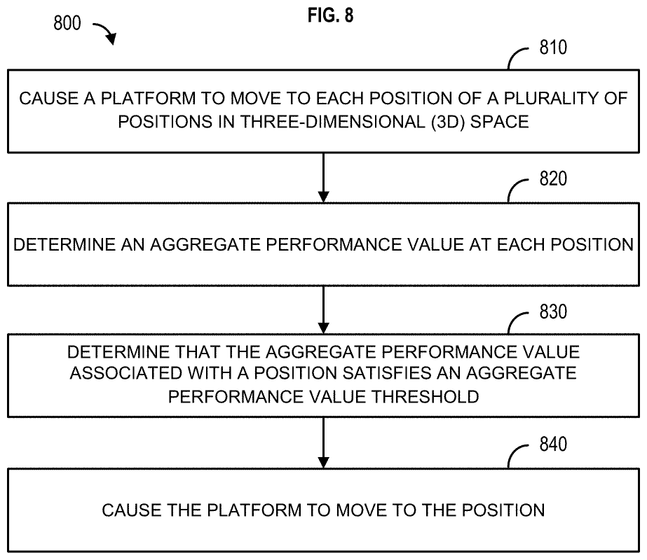

FIG. 8 is a flowchart of an example method 800 for optimal antenna positioning. A network device (e.g., a gateway device, a Wi-Fi modem, a router, an access point, a smart device, the network device 102, the network device 201, etc.), for example, a network device configured within a private and/or public network, may wirelessly communicate with multiple user devices. For example, the network device may be configured with a plurality of antennas that enable wireless communication with one or more user devices, such as mobile devices, smart devices, Internet-of-things (IoT) devices, computing devices, and/or the like. The network device may dynamically position and/or reposition the plurality of antennas to achieve optimal aggregate performance (e.g., data throughput, signal power, signal integrity, etc.) when communicating with the one or more user devices. For example, the one or more user devices may be positioned at various distances and/or locations relative to the network device. The network device may position and/or reposition the one or more positional antennas and/or antenna units to achieve optimal aggregate performance based on the various distances and/or locations of the one or more user devices relative to the network device.

The network device may determine a performance value (e.g., an aggregate performance value, an optimal performance value, a sum of performance values, an average of performance values, a fraction/portion of performance values, a factored value associated with performance values, etc.) based on performance data associated with any combination of antennas and user devices. For example, a network device configured with antennas A, B, and C, and in communication with user devices 1, 2, and 3, may determine a performance value based on performance data associated with different combinations of antenna and user devices such as: only antenna A; only antenna B; only antenna C; antennas A and B; antennas A and C; and/or antennas A, B, and C, combined with: only user device 1; only user device 2; only user device 3; user devices 1 and 2, user devices 1 and 3, and/or user devices 1, 2, and 3.

At 810, the network device may cause a platform (e.g., a disk, a surface, an apparatus, etc.) to move to each position of a plurality of positions in three-dimensional (3D) space. For example, a plurality of antenna of the network device may be attached to and/or configured with the platform. The platform may include, for example, a disk, a wafer, and/or the like. The platform may be attached to a 3-axis gimballed gyroscope. The network device may cause, via the gyroscope, the platform to incrementally move to each position in three-dimensional 3D. Each position of the plurality of positions may be separated, for example, by a degree in 3D space. Each position of the plurality of positions may be separated, for example, by any value in 3D space.

At 820, the network device may determine, at each position of the plurality of positions, an aggregate performance value. The aggregate performance value may be based on performance data associated with each antenna of the plurality of antennas and each device of a plurality of devices in communication with the network device. The performance data associated with each antenna of the plurality of antennas and each device of the plurality of devices comprises at least one of: a received signal strength indicator (RSSI) value associated with each device of the plurality of devices determined by the network device to be associated with the respective antenna, or data throughput associated with each device of the plurality of devices determined by the network device to be associated with the respective antenna.

At 830, the network device may determine that the aggregate performance value associated with a position of the plurality of positions satisfies an aggregate performance value threshold. The aggregate performance value threshold may be based on a historic aggregate performance value determined, for example, based on historic performance data associated with each antenna of the plurality of antennas and each device of a plurality of devices previously in communication with the network device.

At 840, the network device may assign the position as a static position for the platform. The network device may cause the platform to move to the static position. To cause the platform to move to the static position, the network device may be configured with one or more actuators. The network device may actuate the one or more actuators to cause the platform to move to the static position. The one or more actuators may include one or more stepper motors, one or more DC motors, one or more AC motors, and/or any other actuators. For example, the one or more actuators may drive at least three gimbals attached to the platform. Each gimbal of the three gimbals may be associated with a respective axis in 3D space. A gyroscopic effect associated with each gimbal of the at least three gimbals along each direction of the respective axis in 3D space may cause any gimbal of the at least three gimbals to move to a stable position if an external force disturbs a position of the gimbal. For example, inertial guidance may be used to stabilize the platform to mitigate any unintentional movement of the platform.

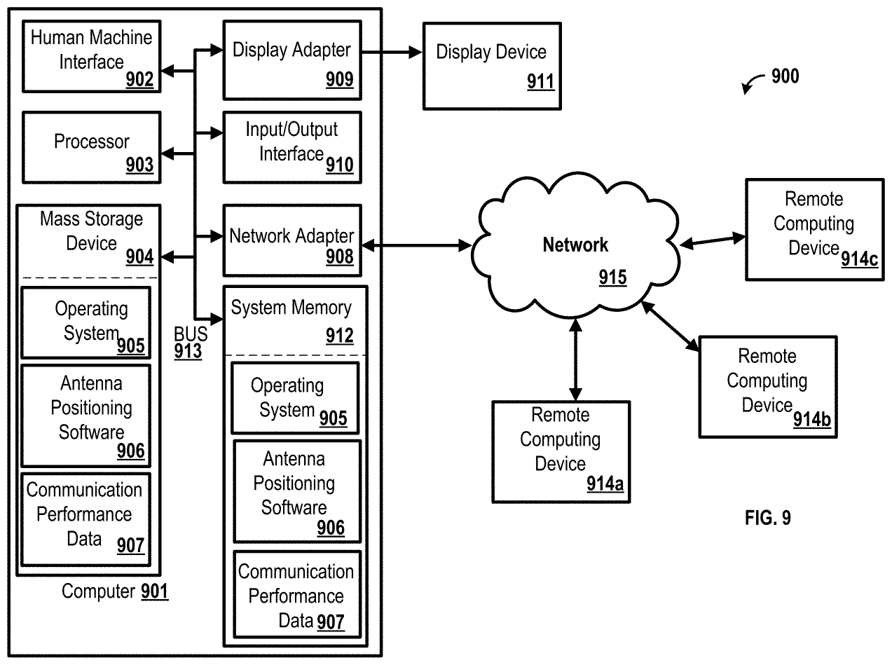

FIG. 9 shows a system 900 for optimal antenna positioning. Any device/component described herein may be a computer 901 as shown in FIG. 9.

The computer 901 may comprise one or more processors 903, a system memory 912, and a bus 913 that couples various components of the computer 901 including the one or more processors 903 to the system memory 912. In the case of multiple processors 903, the computer 901 may utilize parallel computing.

The bus 913 may comprise one or more of several possible types of bus structures, such as a memory bus, memory controller, a peripheral bus, an accelerated graphics port, and a processor or local bus using any of a variety of bus architectures.

The computer 901 may operate on and/or comprise a variety of computer readable media (e.g., non-transitory). Computer readable media may be any available media that is accessible by the computer 901 and comprises, non-transitory, volatile and/or non-volatile media, removable and non-removable media. The system memory 912 has computer readable media in the form of volatile memory, such as random access memory (RAM), and/or non-volatile memory, such as read-only memory (ROM). The system memory 912 may store data such as communication performance data 907 and/or program modules such as operating system 905 and antenna positioning software 906 that are accessible to and/or are operated on by the one or more processors 903.

The computer 901 may also comprise other removable/non-removable, volatile/non-volatile computer storage media. The mass storage device 904 may provide non-volatile storage of computer code, computer readable instructions, data structures, program modules, and other data for the computer 901. The mass storage device 904 may be a hard disk, a removable magnetic disk, a removable optical disk, magnetic cassettes or other magnetic storage devices, flash memory cards, CD-ROM, digital versatile disks (DVD) or other optical storage, random access memories (RAM), read-only memories (ROM), electrically erasable programmable read-only memory (EEPROM), and the like.

Any number of program modules may be stored on the mass storage device 904. An operating system 905 and antenna positioning software 906 may be stored on the mass storage device 904. One or more of the operating system 905 and antenna positioning software 906 (or some combination thereof) may comprise program modules and the antenna positioning software 906. Communication performance data 907 may also be stored on the mass storage device 904. Communication performance data 907 may be stored in any of one or more databases known in the art. The databases may be centralized or distributed across multiple locations within the network 915.

A user may enter commands and information into the computer 901 via an input device (not shown). Such input devices comprise, but are not limited to, a keyboard, pointing device (e.g., a computer mouse, remote control), a microphone, a joystick, a scanner, tactile input devices such as gloves, and other body coverings, motion sensor, and the like These and other input devices may be connected to the one or more processors 903 via a human machine interface 902 that is coupled to the bus 913, but may be connected by other interface and bus structures, such as a parallel port, game port, an IEEE 1394 Port (also known as a Firewire port), a serial port, network adapter 908, and/or a universal serial bus (USB).

A display device 911 may also be connected to the bus 913 via an interface, such as a display adapter 909. It is contemplated that the computer 901 may have more than one display adapter 909 and the computer 901 may have more than one display device 911. A display device 911 may be a monitor, an LCD (Liquid Crystal Display), light-emitting diode (LED) display, television, smart lens, smart glass, and/or a projector. In addition to the display device 911, other output peripheral devices may comprise components such as speakers (not shown) and a printer (not shown) which may be connected to the computer 901 via Input/Output Interface 910. Any step and/or result of the methods may be output (or caused to be output) in any form to an output device. Such output may be any form of visual representation, including, but not limited to, textual, graphical, animation, audio, tactile, and the like. The display 911 and computer 901 may be part of one device, or separate devices.

The computer 901 may operate in a networked environment using logical connections to one or more remote computing devices 914a,b,c. A remote computing device 914a,b,c may be a personal computer, computing station (e.g., workstation), portable computer (e.g., laptop, mobile phone, tablet device), smart device (e.g., smartphone, smartwatch, activity tracker, smart apparel, smart accessory), security and/or monitoring device, a server, a router, a network computer, a peer device, edge device or other common network nodes, and so on. Logical connections between the computer 901 and a remote computing device 914a,b,c may be made via a network 915, such as a local area network (LAN) and/or a general wide area network (WAN). Such network connections may be through a network adapter 908. A network adapter 908 may be implemented in both wired and wireless environments. Such networking environments are conventional and commonplace in dwellings, offices, enterprise-wide computer networks, intranets, and the Internet.

Application programs and other executable program components such as the operating system 905 are shown herein as discrete blocks, although it is recognized that such programs and components may reside at various times in different storage components of the computing device 901, and are executed by the one or more processors 903 of the computer 901. An implementation of antenna positioning software 906 may be stored on or sent across some form of computer readable media. Any of the disclosed methods may be performed by processor-executable instructions embodied on computer readable media.

While specific configurations have been described, it is not intended that the scope be limited to the particular configurations set forth, as the configurations herein are intended in all respects to be possible configurations rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

What is claimed is:

1. A method comprising:
causing each antenna of a plurality of antennas of a network device to move to a plurality of positions in a three-dimensional (3D) space;
determining, based on a performance of each antenna of the plurality of antennas at each of the plurality of positions, and based on a performance associated with a plurality of devices in communication with the network device, an aggregate performance value;
determining, for each antenna of the plurality of antennas, a position of the plurality of positions associated with a highest aggregate performance value; and
causing each antenna of the plurality of antennas to move to the position of the plurality of positions associated with the highest aggregate performance value.

2. The method of claim 1, wherein each position of the plurality of positions is separated by a configurable angle in 3D space that ranges from 1 to 180 degrees.

3. The method of claim 1, wherein the performance of with each antenna of the plurality of antennas and the performance associated with each device of the plurality of devices comprises at least one of: a received signal strength indicator (RSSI) value, or Signal to Noise Ratio (SNR) associated with each device of the plurality of devices determined by the antenna, or data throughput associated with each device of the plurality of devices determined by the antenna.

4. The method of claim 1, wherein determining, for each antenna of the plurality of antennas, the position of the plurality of positions associated with the highest aggregate performance value comprises:
causing each antenna of the plurality of antennas to move to a first position of the plurality of positions;
assigning a first aggregate performance value associated with the first positions as the highest aggregate performance value;
causing each antenna of the plurality of antennas to move to a second position of the plurality of positions;
determining that a second aggregate performance value associated with the second positions is higher than the first aggregate performance value; and
assigning, based on determining that the second aggregate performance value is higher than the first aggregate performance value, the second aggregate performance value as the highest aggregate performance value.

5. The method of claim 4, wherein the first aggregate performance value is based on first performance data associated with each antenna of the plurality of antennas and each device of the plurality of devices, and the second aggregate performance value is based on second performance data associated with each antenna of the plurality of antennas and each device of the plurality of devices.

6. The method of claim 1, wherein determining, for each antenna of the plurality of antennas, the position of the plurality of positions associated with the highest aggregate performance value comprises:
comparing the aggregate performance values determined at the positions of the plurality of positions to aggregate performance values determined at remaining positions of the plurality of positions; and
determining, based on the comparison, that the positions of the plurality of positions are associated with the highest aggregate performance value.

7. The method of claim 1, further comprising assigning the positions of the plurality of positions associated with the highest aggregate performance value as static positions for the plurality of antennas.

8. The method of claim 1, wherein causing each antenna of the plurality of antennas to move to the positions of the plurality of positions associated with the highest aggregate performance value comprises actuating one or more actuators that cause each antenna of the plurality of antennas to move to the positions.

9. The method of claim 8, wherein the one or more actuators comprise one or more stepper motors.

10. A method comprising:
causing each antenna of a plurality of antennas of a network device to move to a plurality of positions in a three-dimensional (3D) space;
determining, based on a performance of each antenna of the plurality of antennas at each of the plurality of positions, and based on a performance associated with a plurality of devices in communication with the network device, an aggregate performance value;
determining, for each antenna of the plurality of antennas, the position of the plurality of positions associated with the aggregate performance value that satisfies an aggregate performance value threshold; and
causing each antenna of the plurality of antennas to move to the position of the plurality of positions associated with the aggregate performance value that satisfies the aggregate performance value threshold.

11. The method of claim 10, wherein each position of the plurality of positions is separated by a configurable angle in 3D space that ranges from 1 to 180 degrees.

12. The method of claim 10, wherein the performance data associated with each antenna of the plurality of antennas and each device of the plurality of devices comprises at least one of: a received signal strength indicator (RSSI) value associated with each device of the plurality of devices determined by the antenna, or data throughput associated with each device of the plurality of devices determined by the antenna.

13. The method of claim 10, wherein the aggregate performance value threshold is based on a historic aggregate performance value, wherein the historic aggregate performance value is based on historic performance data associated with each antenna of the plurality of antennas and each device of a plurality of devices previously in communication with the network device.

14. The method of claim 10, further comprising assigning the positions of the plurality of positions associated with the aggregate performance value that satisfies the aggregate performance value threshold as static positions for the plurality of antennas.

15. The method of claim 10, wherein causing each antenna of the plurality of antennas to move to the position of the plurality of positions associated with the aggregate performance value that satisfies the aggregate performance value threshold comprises actuating one or more actuators that cause each antenna of the plurality of antennas to move to the position.

16. The method of claim 15, wherein the one or more actuators comprise one or more stepper motors driving at least three gimbals associated with each antenna of the plurality of antennas, wherein each gimbal of the three gimbals is associated with a respective axis in 3D space.

17. The method of claim 16, wherein a gyroscopic effect associated with each gimbal of the at least three gimbals along each direction of the respective axis in 3D space causes any gimbal of the at least three gimbals to move to a stable position if an external force disturbs a position of the gimbal.

18. A method comprising:
causing an apparatus to move to each position of a plurality of positions in a three-dimensional (3D) space, wherein the apparatus comprises a plurality of antennas of a network device;
determining, based on a performance of each antenna of the plurality of antennas at each of the plurality of positions, and based on a performance associated with a plurality of devices in communication with the network device, an aggregate performance value;
determining that the aggregate performance value associated with a position of the plurality of positions is a highest aggregate performance value; and
causing the apparatus to move to the position.

19. The method of claim 18, wherein each position of the plurality of positions is separated by a configurable angle in 3D space that ranges from 1 to 180 degrees.

20. The method of claim 18, wherein the performance data associated with each antenna of the plurality of antennas and each device of the plurality of devices comprises at least one of: a received signal strength indicator (RSSI) value associated with each device of the plurality of devices determined to be in communication with the network device, or data throughput associated with each device of the plurality of devices determined to be in communication with the network device.
